(19) United States
(12) Patent Application Publication
(10) Pub. No.: US 2012/0233205 A1
(43) Pub. Date: Sep. 13, 2012

(54) SYSTEM AND METHOD FOR DOCUMENT MANAGEMENT

(75) Inventor: David D. McDermott, Topeka, KS (US)

(73) Assignee: INWARE, LLC, Independence, OH (US)

(21) Appl. No.: 13/478,626

(22) Filed: May 23, 2012

Related U.S. Application Data
(63) Continuation-in-part of application No. 12/044,300, filed on Mar. 7, 2008.

(51) Int. Cl. G06F 17/00; G06F 17/30

(52) U.S. Cl. 707/769; 715/255; 707/E17.014

(57) ABSTRACT

Systems and methods for uploading one or more documents to a document management database are presented. The system can include a memory, a listener component that detects when a document has been dragged or dropped onto a persistent doc drop element, and a doc drop module that, as a function of the document being dragged or dropped onto the persistent doc drop element, converts the document into a portable document format and queues a converted document to a task specific queue, and in response to a user terminating a task associated with the task specific queue, uploads content queued in the task specific queue to a database associated with a web service.

### PRIORITY CLAIM

This application is a Continuation-in-Part of co-pending U.S. patent application Ser. No. 12/044,300, entitled “SYSTEM AND METHOD FOR DOCUMENT MANAGEMENT”, filed on Mar. 7, 2008, the disclosure of which is hereby incorporated by reference.

### TECHNICAL FIELD

The application relates to systems and methods for uploading documents to a document database by using a drag and drop interface that includes a persistent and movable drop box rendered on an operating system.

### BACKGROUND

Organizations often have reams of data and documents that may be stored across disparate databases and other storage devices. This leads to difficulties in uploading documents because it is often a hassle to operate the various interfaces presented by these disparate databases and devices. Other problems arise when attempting to store documents retrieved from applications such as email clients or web browsers. Oftentimes a user must save documents separately, then upload the documents using the aforementioned variety, of interfaces. As a result, various solutions have emerged to help track and manage file upload processes.

However, conventional systems fail to give the user an easy-to-use, configurable interface that enables access to a variety of databases. For example, the user is left to save documents attached in email, for example, then upload the documents separately. Alternatively, the user must use an email client to save the document into a document database directly while navigating difficult to use user interfaces. These interfaces typically fail to provide the user insight as to where the documents should be uploaded.

Conventional systems to upload documents to a document database suffer from these and other problems.

The above-described deficiencies are merely intended to provide an overview of some of the problems of conventional systems and techniques, and are not intended to be exhaustive. Other problems with conventional systems and techniques, and corresponding benefits of the various non-limiting embodiments described herein may become further apparent upon review of the following description.

### SUMMARY

The following presents a simplified summary to provide a basic understanding of some aspects described herein. This summary is not an extensive overview of the disclosed subject matter. It is not intended to identify key or critical elements of the disclosed subject matter, or delineate the scope of the subject disclosure. Its sole purpose is to present some concepts of the disclosed subject matter in a simplified form as a prelude to the more detailed description presented later.

The subject application solving these and other drawbacks of conventional systems relates to a system and method for uploading one or more documents using an efficient user interface.

In some implementations, the efficient user interface may provide a configurable and persistent document drop element (also sometimes referred to as a “doc drop element”) that is movable about a desktop interface of an operating system. The persistent element, which may be or include a semi-transparent icon, may be configured, for example, to interface with a document management database such that information related to the one or more documents may be relayed to the document management database. The persistent element may comprise a persistent area over which an object may be dragged and dropped such as, for example, a sticky icon, hyperlink, window, or other area. The persistent area may be persistently displayed through any other application interface that may be running on the operating system. For example, the persistent area may be continuously visible (although semi-transparent) and accessible even if a web browser, email client, or other application is running on the operating system in which the same pixel space is occupied by their respective interfaces. In other words, the persistent area remains in the foreground of the user interface. This aspect of the subject application enables dragging and dropping an object, for example, from any application or from the desktop of the operating system regardless of other applications running on the operating system. The object may be an icon, for example, that represents one of the one or more documents that are to be uploaded. The drag and drop event may be detected by interfacing with the operating system to listen for, receive, and/or process events that may be relevant to the system of the subject application. For example, drag and drop events using a mouse may be detected. Other events may be detected such as key entries using a keyboard, pointer device indicating an object, and/or other events. In some implementations, detection of the event may indicate a request to upload the object regardless of whether the event is a drag-and-drop, keyboard entry, pointer device, or other event. Upon receiving the event, data regarding the object may be received from the operating system and/or from the user.

In some implementations, for example, if the event is a drag-and-drop, the operating system may be queried to determine the nature of the dragged and dropped object. If the object corresponds to a document, for example, the file location of the document on disk may be ascertained from the operating system. Accordingly, the document may be uploaded using the file location to retrieve the source document. In another example, if the event is the actuation of a keyboard short-key, for example, wherein an object is not specified by the keyboard short-key, then a dialog box may be provided to receive input from a user specifying the one or more documents to be uploaded.

In some implementations, once the source location of the one or more documents has been identified, a dialog box may be provided to receive a document type that may be associated with the one or more documents. The document type may be an alias that serves as a name for the one or more documents. The document type may be predefined and each document type may correspond to a document description that describes the document type. For example, the one or more documents may correspond to documents related to sales data, sales agent, or any other category. Descriptions may also be preconfigured to provide any descriptive labels such as sales data time periods, particular agent data, or any other descriptive label. Furthermore, the destination location and/or the description of the destination location may be searchable to allow easy identification of the destination location.

According to various implementations, the document type may be communicated to the document management database using an interface associated with the document management. Thus, in operation, for example, the one or more documents may be dragged over the persistent doc drop element for rapid document identification and subsequent upload to the document management database.

In accordance with further embodiments, the subject application describes a system, comprising: a memory, a listener component that detects when a document has been dragged or dropped onto a persistent doc drop element, and a doc drop module that, as a function of the document being dragged or dropped onto the persistent doc drop element, converts the document into a portable document format and queues a converted document to a task specific queue, and in response to a user terminating a task associated with the task specific queue, uploads content queued in the task specific queue to a database associated with a web service.

In accordance with yet further embodiments, the subject application describes a method, comprising: listening for a drag or drop event, wherein a document is dragged or dropped over a persistent doc drop element, transforming the document from a first document format to a second document format, placing the document transformed to the second document format into a task specific queue or a format specific queue; and transferring the document transformed to the second document format from the task specific queue or the format specific queue to a document management database associated with a web service.

In accordance with still further embodiments, the subject application describes a system, comprising: at least one non-transitory computer readable medium having stored thereon computer-executable components, at least one microprocessor that executes the following computer executable components stored on the at least one non-transitory computer readable medium: a listener component that detects an event that includes reception of a document formatted in a first data format by a persistent doc drop element, a queue component that transforms the document formatted in the first format into a document formatted in a second data format, wherein the document formatted in the second format is placed in a task specific queue that is maintained in a hold state; and a database interface component that transfers the document formatted in the second format to a document management database associated with a web service in response to the task specific queue being released from the hold state.

The following description and the annexed drawings set forth in detail certain illustrative aspects of the disclosed subject matter. These aspects are indicative, however, of but a few of the various ways in which the principles of the subject application can be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an exemplary system for uploading one or more documents to a database according to various implementations of the disclosure.

FIG. 2A illustrates an exemplary desktop interface, according to various aspects of the disclosure.

FIG. 2B illustrates an example of a persistent doc drop element 108 visible through an email application being displayed on a desktop interface, according to various aspects of the disclosure.

FIG. 3 illustrates an exemplary dialog box for receiving input from a user to upload one or more documents to a document management database according to various implementations of the disclosure.

FIG. 4 illustrates an exemplary process for user interaction with a doc drop module, according to various implementations of the disclosure.

FIG. 5 illustrates an exemplary process for initiating an upload, according to various implementations of the disclosure.

FIG. 6 illustrates an exemplary process for uploading one or more documents to a document management database, according to various implementations of the subject application.

FIG. 7 provides a further illustration of a non-limiting example system for uploading one or more documents to a database.

FIG. 8 provides depiction of a non-limiting example doc drop module in accordance with one or more embodiments of the subject application.

FIGS. 9A and 9 B illustrate non-limiting examples of a persistent doc drop element in accordance with one or more aspects of the subject application.

FIG. 10 provides depiction of a non-limiting example method that can be utilized uploading one or more documents to a document management database in accordance with various aspects of the subject application.

FIG. 11 illustrates a block diagram of a computing system operable to execute the disclosed systems and methods, in accordance with an embodiment.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to select appropriate relay stations for secondary transmitter and secondary receivers randomly situated within a cognitive radio network, wherein the secondary receiver and secondary transmitter can base their respective decisions as to which relay station is the most suitable relay station at least in part on links between the relay station and the secondary receiver and the secondary transmitter and the relay station.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

A system and method for providing an interface for uploading one or more documents to a document management database may be provided.

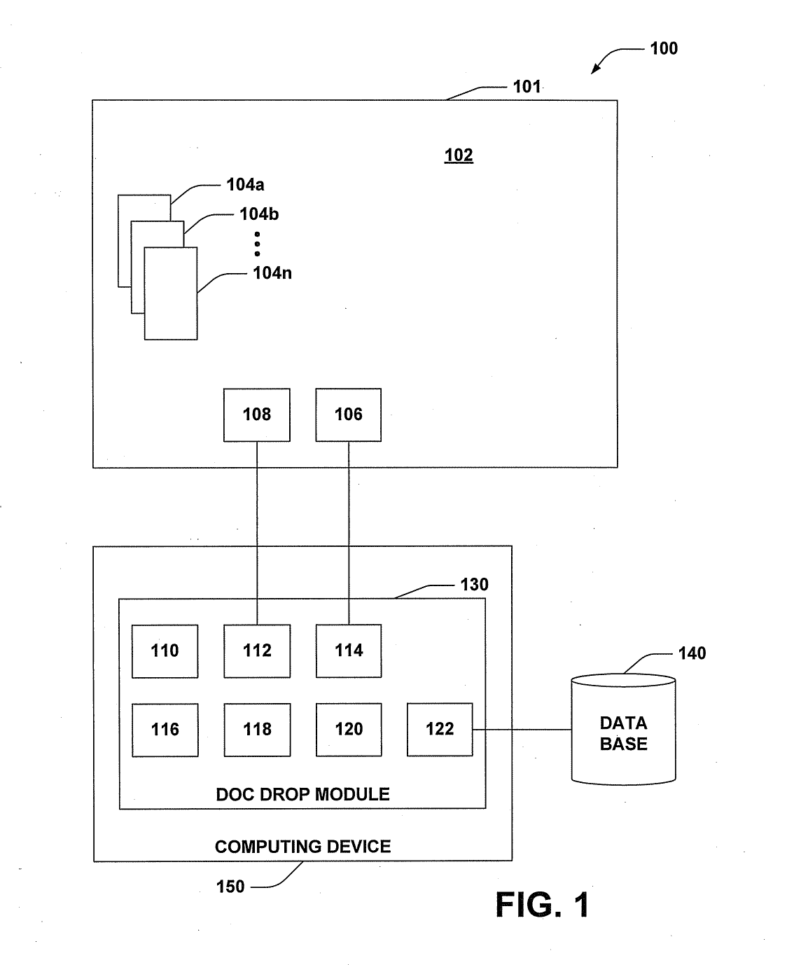

FIG. 1 illustrates an exemplary schematic diagram of a system 100 for providing an interface to upload one or more documents 104a-104n to a database 140. The term document may refer to any dataset such as a word processing document, an image file, a movie file, a sound file, database entry, and/or any other dataset and/or data file. Documents 104a-104n may be depicted on a desktop interface 102 in a conventional manner as would be appreciated. For example, documents 104a-104n may be depicted using an icon, textual list, image, and/or other depiction. Furthermore, as used herein, the term document may be used interchangeability with the term “document depictions.”

According to various implementations of the invention, system 100 may include hardware and/or software modules, such as a doc drop module 130. Doc drop module 130 may include one or more of the following modules: an operating system (“O/S”) interface module 110, a drop doc generator module 112, a user interface module 114, listener module 116, a login module 118, an administrative module 120, a database interface module 122, and/or other modules.

In some implementations, OS interface module 110 may query, interface, or otherwise interact with an operating system of computing device 150. Interactions may include polling the operating system for resources, detecting hardware events (such as mouse-tracking), determining the file location of one or more documents, and/or other interactions. In some implementations doc drop generator module 112 may generate a persistent doc drop element 108 on desktop interface 102 in conjunction with OS interface module 110. Doc drop generator module 112 may create a persistent doc drop element 108, which is semi-transparent, always visible and accessible about the foreground of desktop interface 102, and may comprise a sticky icon, hyperlink, window, or other area that is movable about desktop interface 102. In some embodiments, the degree of transparency of persistent doc drop element 108 may be modified, configured, or otherwise varied. Doc drop generator module 112 may be implemented, for example, using any computing language that enables generation of graphical on the operating system. User Interface (UI) module 114 may generate a GUI 106 rendered on desktop interface 102. GUI 106 may present the user with selectable options and/or otherwise enable users to input data for associated with the one or more documents that will be uploaded to the document management database and options to configure the system. In some implementations, listener module 116 may interface with OS interface module 110 to listen for, receive, and process events that may be relevant to the system. For example, listener module 116 may detect and process events such as drag and drop events using a mouse, key entries using a keyboard, and/or other events.

In some implementations, login module 118 may authenticate a user accessing the system 100 according to methods well known in the art. Such methods may include, for example, use of a shared secret (e.g., a username, password, etc.), authentication based on an input/output device such as a USB device, biometric identification, and/or other authentication method. In some implementations, administrative module 120 may enable system administrative functions such as, for example, configuring system 100 to interact with particular databases, setting account information (e.g., username and passwords), defining controlled vocabularies used by system 100, setting the transparency properties of persistent doc drop element 108, and/or other administrative functions. In some implementations, database interface module 122 may access and/or interface with database 140 to perform database operations such as, for example, insert, retrieve, update, and/or perform other database operations. For example, database 140 may store and retrieve the controlled vocabularies using database interface module 122. Database interface module 122 may associate persistent doc drop element 108 with a document management database. Although otherwise not illustrated, the document management database may be a third party database, may comprise database 140, may be part of database 140, or any other combination. Modules described herein are exemplary and that modules may interface with one another to perform a particular task. Furthermore, one or more modules may be combined and additional modules may be used as appropriate.

In some implementations, doc drop module 130 may be executed on a computing device 150. Computing device 150 may be any computing device such as, for example, a server, a desktop computer, laptop computer, personal digital assistant, smart phone, and/or any other computing device. Other configurations and system architectures may be used. For example, although not shown, computing device 150 may be or include one or more servers connected to one or more clients via a network such as a Wireless Area Network, Local Area Network, the Internet, and/or other network or combination thereof. Computing device 150 may be coupled to at least one database 140 that stores system data such as a plurality of document types and associated document descriptions, administrative information, or any other data. Database 140 may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Standard Query Language), a SAN (storage area network), Microsoft Access™ or others may also be used, incorporated, or accessed. Although illustrated as being separate from computing device 150, database 140 may be part of or hosted by computing device 150.

System 100 may also include a display 101. Display 101 may be any display known in the art. Display 101 may display desktop interface 102.

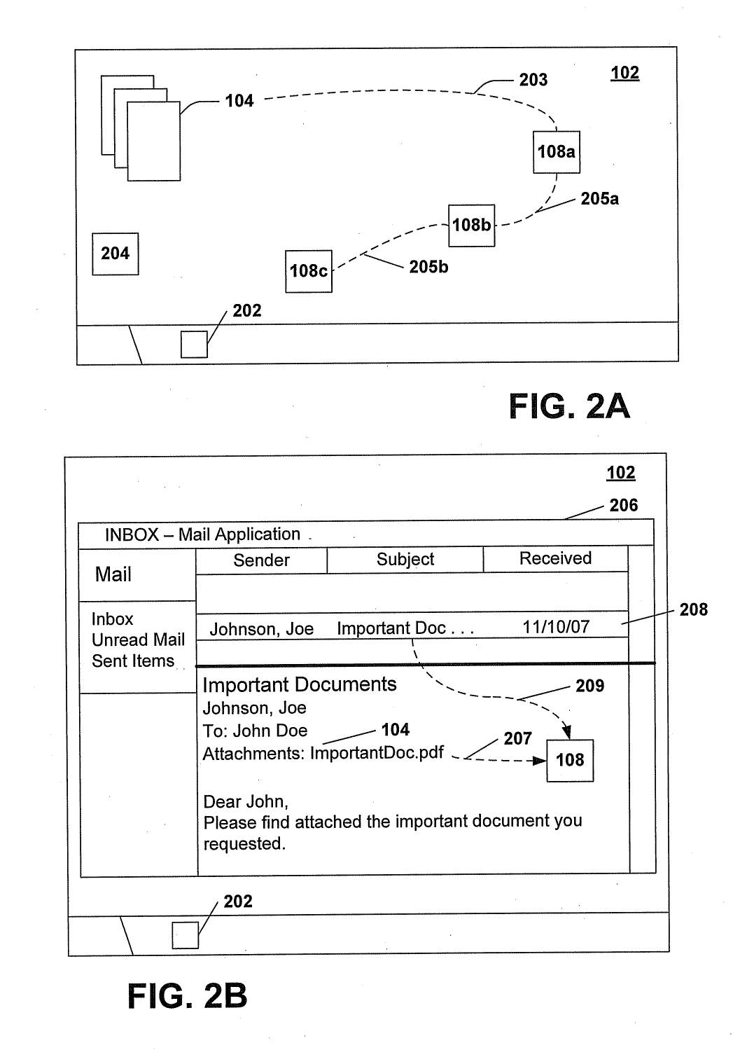

FIG. 2A illustrates an exemplary representation of persistent doc drop element 108 on desktop interface 102 according to various implementations of the invention. In some implementations, upon installation of doc drop module 130, a tray icon 202 may be installed on a tray of the operating system and a shortcut icon 204 may be installed on desktop interface 102 as would be appreciated by those having ordinary skill in the art. Clicking or otherwise selecting tray icon 202 may enable access to system configurations via the administrative module 114, as described herein elsewhere. One or more documents 104a-104n may be dragged across desktop interface 102 and dropped at or near persistent doc drop element 108 following imaginary path 203 or other path. Doing so initiates a request to upload the dragged and dropped one or more documents 104. Persistent doc drop element 108 may be moved about desktop interface 102 following an imaginary path such as, for example, path 205a-b, or any other path. By doing so, persistent doc drop element 108 may be placed in any location about desktop interface 102 such as, for example, locations 108a, 108b, 108c, or any other location about desktop interface 102.

FIG. 2B illustrates an exemplary representation of persistent doc drop element 108 as seen through an email application 206 running on desktop interface 102. Upon initializing email application 206 running on desktop interface 102, a user interface of the email application 206 may occupy the same pixel locations as persistent doc drop element 108. Ordinarily, a typical icon will be obscured and inaccessible without minimizing, closing, or otherwise moving the overlapping application. Furthermore, icons in toolbars of an operating system, for example, remain fixed to the toolbar. However, as illustrated in FIG. 2B, doc drop 208 remains visible, accessible, and movable about desktop interface 102, maintaining the same functionality as set forth above in FIG. 2A. Thus, one or more documents displayed or embedded within email application 206, for example, may be dragged and dropped across email application 206 and/or desktop interface 102 following, for example, imaginary path 207 or other path to persistent doc drop element 108. In some implementations, a message thread 208 including attached one or more documents 104a-104n may be dragged and dropped across email application 206 and/or desktop interface 102 following imaginary path 209 or other path to persistent doc drop element 108. Although described herein as a drag and drop function, any other input method to indicate a request to upload the one or more documents to the database may be used such as the use of quick keys or other hot keys, other mouse actions, and/or other input methods.

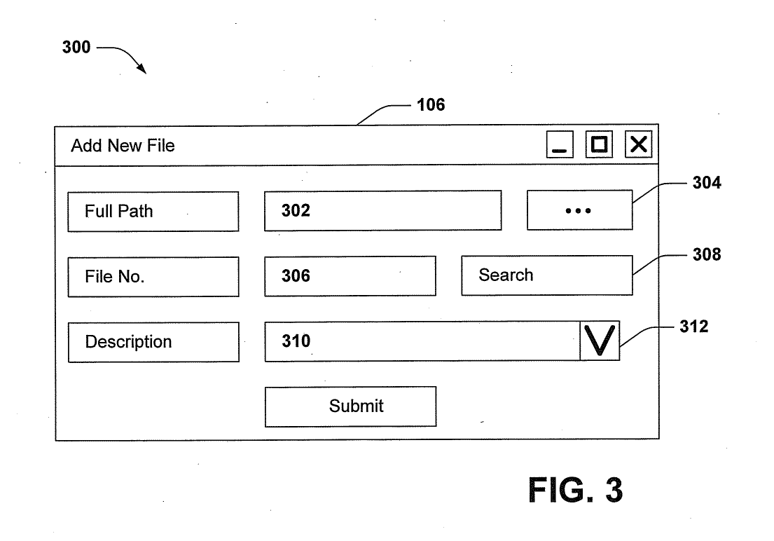

FIG. 3 illustrates an exemplary GUI 106 according to various implementations. In some implementations, GUI 106 may be presented when a request to upload the one or more documents is detected. This detection may result, for example, from a drag and drop into persistent doc drop element 108. GUI 106 may present one or more input forms to a user and GUI 106 may be implemented using any interface input format such as, for example, a hyper-text markup language form or any other interface input format. For example, if one or more documents are dropped over persistent doc drop element 108 by the user, GUI 106 may present the user with a form to enter data associated with the dropped one or more documents. In this case, because the one or more documents was dropped over persistent doc drop element 108, a file input entry 302 may be pre-filled with information regarding the source location of the dropped one or more documents. In some implementations, a browse button 304 may be used to change the location of the dropped one or more documents. However, if the request to upload the one or more documents was not from a drag and drop event (but was, for example, the result of a keyboard shortcut key input “F2” or other action), then the user may input the location of the one or more documents using browse button 304 or otherwise provide the source location to GUI 106.

In some implementations, the user may then use destination entry 306 to enter an identifier associated with a destination location to which the one or more documents is to be uploaded. If known, the user may enter the identifier into destination entry 306. If unknown, the user may launch a search for the identifier by clicking or otherwise selecting destination search button 308. As used herein “button” may be any input indicator such as a form button, hyperlink, or other input indicator. In some implementations, the user may enter a description in to description entry 310. The description may correspond to a specific destination location for the one or more documents. In some implementations, descriptions may be controlled by the administrator as a controlled vocabulary, as would be appreciated. In some implementations, the description may be entered by the user outside of a controlled vocabulary. The description may be used during searches launched by destination search button 308 to help the user identify an appropriate destination location for the one or more documents. In some implementations, the user may click or otherwise select description selector 312 to select from a list of descriptions.

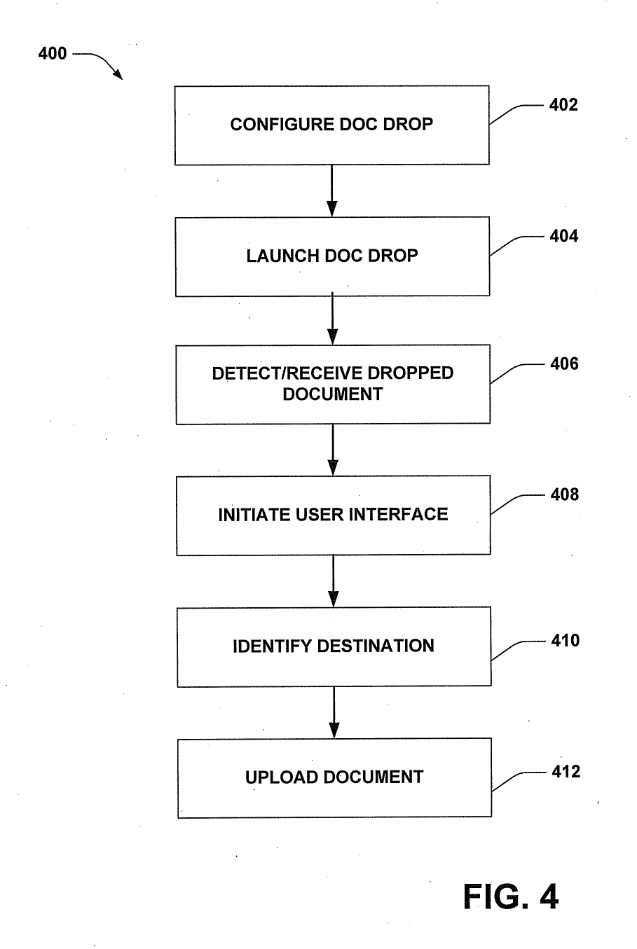

FIG. 4 illustrates a process 400 for uploading one or more documents to database 140 according to various implementations of the invention. The described operations may be accomplished using some or all of the system components described in detail above and, in some implementations, various operations may be performed in different sequences. In other implementations, additional operations may be performed along with some or all of the operations shown in FIG. 4. In yet other implementations, one or more operations may be performed simultaneously. Accordingly, the operations described are exemplary in nature and, as such, should not be viewed as limiting.

In an operation 402, an administrator may configure the system. Configurations may include system functions such as setting/changing passwords, defining destination location controlled vocabularies, associating the system with one or more databases, and/or other system functions. In an operation 404, a user may initiate a system according to one of various implementations of the invention. After system initiation doc drop module 130 may generate persistent doc drop element 108 onto desktop interface 102 and begin listening for event inputs. As discussed elsewhere herein, event inputs may be drag and drop event inputs, keyboard shortcut key input, or any other input as would be appreciated by those skilled in the art.

In an operation 406, one or more event inputs to upload one or more documents may be received and/or detected. Once the one or more event inputs are received and/or detected, a user interface may be generated and provided to the user in an operation 408. The location of the one or more documents to be uploaded is identified. For example, if the input is a drag and drop of the one or more documents, then the location of the one or more documents that was dragged and dropped is used. In some implementations, the user may input the location of the one or more documents to be uploaded.

In an operation 410, the location of the destination may be identified. Identification may comprise the user entering in an identifier associated with the destination location. Alternatively or additionally, the user may initiate a search to find destination locations previously used. A description of the destination location may be included. The description may be entered by the user and/or selected from a list of descriptions.

In an operation 412, the one or more documents may be uploaded to the database 140 based at least in part on the destination location. Uploading to the database may include a file copy to a file-based database, image copy of the one or more documents to a document image database, and/or other database upload technique, which are known in the art. Each of the uploaded one or more documents may be assigned a unique document identifier wherein each document identifier is associated with the destination location identifier. The association may be stored in database 140. Accordingly, the one or more documents may be located by querying the association between the document identifier and the destination location identifier. Thus, uploading to database 140 may include datasets comprising the one or more documents, association, and/or other datasets.

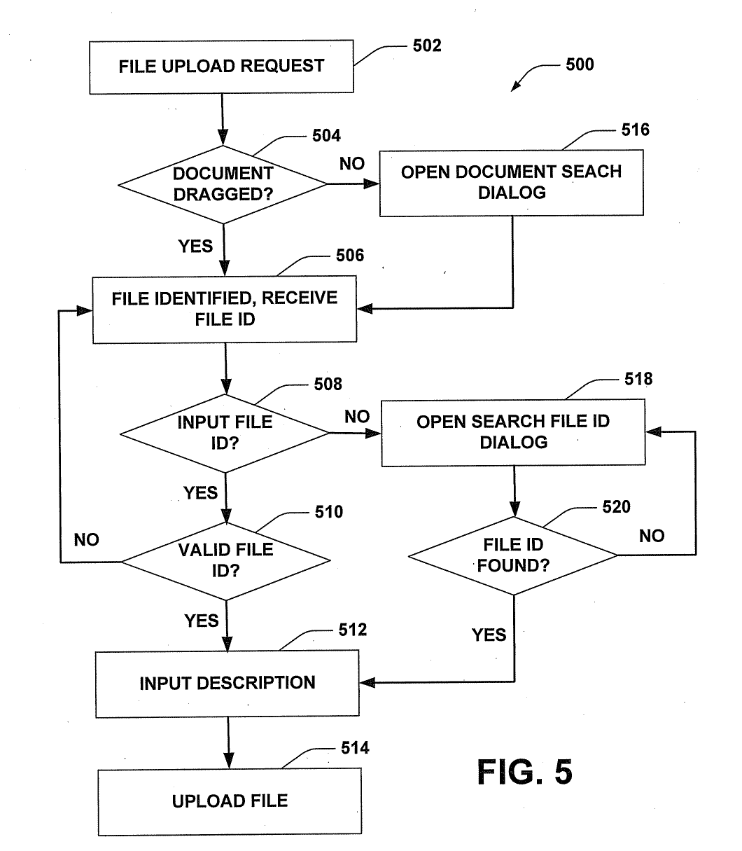

FIG. 5 illustrates a process 500 for preparing datasets for upload to database 140 according to various implementations of the invention. The described operations may be accomplished using some or all of the system components described in detail above and, in some implementations, various operations may be performed in different sequences. In other implementations, additional operations may be performed along with some or all of the operations shown in FIG. 5. In yet other implementations, one or more operations may be performed simultaneously. Accordingly, the operations described are exemplary in nature and, as such, should not be viewed as limiting.

In an operation 502, a request may be made to upload one or more documents. If in an operation 504, the request is based on a drag and drop of the one or more documents over persistent doc drop element 108, then process 500 may proceed to an operation 506, wherein the one or more documents is identified based at least in part on the drag and drop. Operation 506 may also include receiving a document type associated with the one or more documents. Returning to operation 504, if the request is not based on a drag and drop or other method that identifies the one or more documents to be uploaded, processing may proceed to an operation 516, wherein a document search (“browse file”) is provided. When the one or more document is selected using the document search, processing may proceed to operation 506, wherein the one or more documents is identified and the destination location is received.

If in an operation 508 a document type is received, then processing may proceed to an operation 510, wherein the document type may be validated. If valid, then process 500 may proceed to an operation 512, wherein a description may be associated with the document type. Process 500 may then proceed to an operation 514, wherein datasets such as the one or more documents, document type, document description and/or other datasets are conveyed to the document management database. Returning to operation 510, if the destination location is not valid, then processing may return to an operation 506, wherein document type is received.

Returning to operation 508, if the document type is not received, then processing may proceed to an operation 518, wherein a document type search may be provided. If a document type is received and has been found in an operation 520, then processing may proceed to operation 512, wherein a document description is associated with the document type. Returning to operation 520, if the document type has been received but not found, then processing may return to an operation 518, wherein the document type location search may be provided.

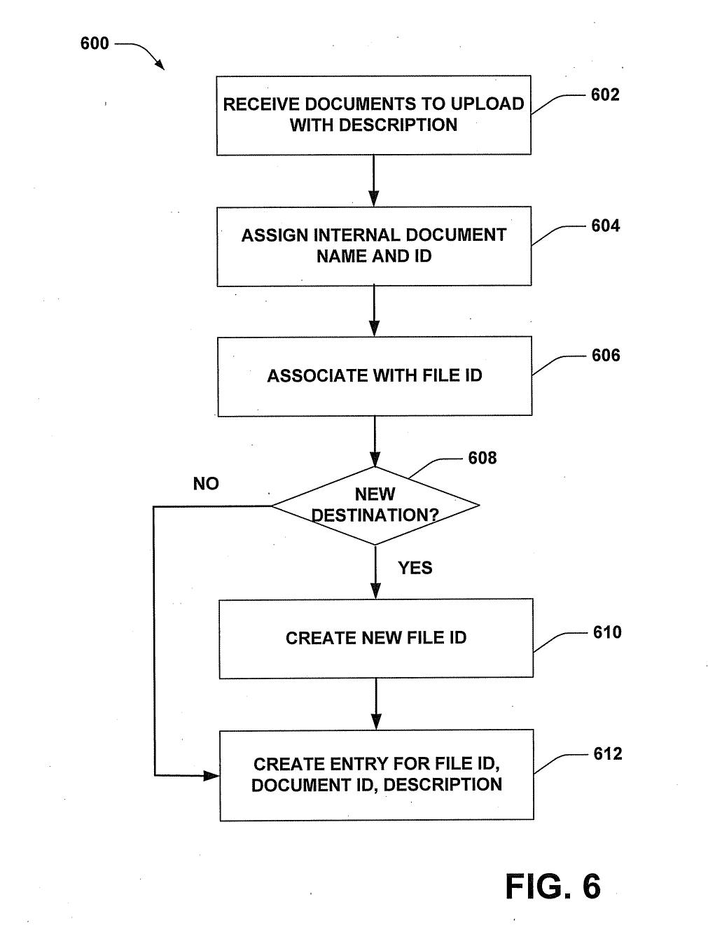

FIG. 6 illustrates a process 600 for uploading datasets to database 140 according to various implementations of the invention. The described operations may be accomplished using some or all of the system components described in detail above and, in some implementations, various operations may be performed in different sequences. In other implementations, additional operations may be performed along with some or all of the operations shown in FIG. 6. In yet other implementations, one or more operations may be performed simultaneously. Accordingly, the operations described are exemplary in nature and, as such, should not be viewed as limiting.

Process 600 may include an operation 602, wherein the one or more documents may be received with a destination description. In an operation 604, a unique identifier may be assigned to each of the one or more documents. In an operation 606, the one or more documents and destination description may be associated with a destination identifier. If in an operation 608 the datasets are to be uploaded to a new destination, then processing may proceed to an operation 610, wherein a new destination and an identifier for that destination is generated. In an operation 612, the datasets comprising the one or more documents, destination, destination description, and/or other datasets are associated to one another and uploaded to database 140. It should be understood that entries comprising the associations may be uploaded to database 140 in a separate or in the same operation. Returning to operation 608, if a new destination is not to be used, then processing may proceed to operation 612.

Although described herein as uploading datasets to database 140, it should be understood that the invention may use and/or interface with any external database such as a third party document management database to store none, part, or all of the datasets.

Implementations of the invention including any modules described herein may be made in hardware, firmware, software, or any suitable combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

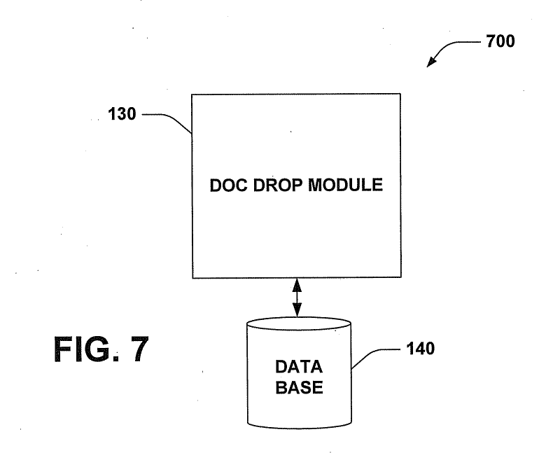

Turning now to FIG. 7 that in accordance with further disclosed embodiments provides a more detailed depiction of doc drop module 130. As has been elucidated above in relation with FIG. 1, doc drop module 130 can include operating system interface module 110 that can query, interface, or interact with the underlying operating system executing on computing device 150. Typical interactions that can take place between the operating system interface module 110 and the underlying operating system executing on computing device 150 can include polling the operating system for resources, detecting hardware events, determining file locations of documents, and the like.

Further, in conjunction with doc drop generator module 112, for example, operating system interface module 110, can generate persistent doc drop element 108 displayed on desktop interface 102, wherein the doc drop element 108 can be selectively opaque, semi-transparent, translucent, or selectively transparent. Further, the displayed persistent doc drop element 108 can always be accessible and usable on desktop interface 102.

Doc drop generator module 112 in association with user interface module 114 can generate a graphical user interface 106 rendered on desktop interface 102. Graphical user interface 106 presents users, with selectable options and/or enables users to enter data associated with documents to be uploaded to document management databases (e.g., database 140) and/or configuration parameters. Moreover, as stated above, operating system interface module 110 in association with listener module 116 can detect and/or listen for drag and drop events that use a mouse, keyboard, and/or other events.

In addition, login module 118 can be employed to authenticate a user accessing the system, and administrative module 120 can be utilized to enable users to perform administrative functions such as configuring the system to interact with databases (e.g. database 140), interact with databases associated with internal and/or external webservices, setting account information, opacity or translucency of persistent doc drop element 108, and/or other administrative functions. Further, database interface module 122 can provide access and/or interface with one or more databases (e.g. database 140). Database interface module 122 can perform database operations such as insert, retrieve, update, and/or other database functions and operations.

In addition to the functionalities provided by the foregoing modules, doc drop module 130, alone or in conjunction with other enumerated components (e.g., desktop interface 102, graphical user interface 106, persistent doc drop element 108, . . . ) can also provide facilities to convert documents dropped into/onto persistent doc drop element 108 into one or more document formats. Typical document formats into which documents can be converted can include portable document format (PDF), postscript, structured hypertext markup language (HTML), one or more word processing formats, one or more presentation formats, file formats for, multimedia and/or vector graphics, one or more digital encoding formats, and the like. The converted documents (which can include screen captures that have been dropped onto persistent doc drop element 108) can thereafter be conveyed to a format specific queue. Additionally and/or alternatively, converted documents can be conveyed to one or more database or Web service specific queues, whereupon at the end of the day, for example, the content of each respective queue can be uploaded to the database (e.g., database 140) as respective single files. Additionally and/or alternatively, the contents of format specific queues can periodically, on demand, be uploaded to the database or one or more disparate databases.

In accordance with one or more embodiments, and as will be appreciated by those ordinarily skilled in the art, each format specific queue can typically be placed in a hold state to effectuate the queuing of format specific content, whereupon at the conclusion of a user session, for instance, the queue can be released and queued content can be uploaded or conveyed to the respective databases.

As will be further appreciated by those of ordinary skill in the art, the number of queues associated with the system can be unlimited and each queue can be populated simultaneously. For instance, five format or task specific queues can be opened at a particular instance in time and documents can be queued to each format or task specific queue, wherein each format or task specific queue can be associated with one or more distinct tasks and/or document formats. When a task is deemed to be complete by a user, the content of the particular queue can be uploaded to the database for appropriate processing. Thus for instance, the content of a first queue can be uploaded to the database for processing while content of the remaining queues can be left undisturbed to await an indication that it can be uploaded to a database for further processing.

Additionally, doc drop module 130 can also provide facilities to allow a user to view content of the queues through a format specific viewer (e.g., PDF viewer, postscript viewer, etc.). The format specific viewer allows users to view the content in the queue, ascertain the number of pages or the documents that have been placed in the queue, and/or the size of the content in the queue. Further, the format specific viewer also allows users to view specific or individual documents that have been placed in each of the format specific queues. It should be noted, that anything that is viewable on a computer display or screen can be placed in a format specific queue and thus the format specific viewer can display such content.

Furthermore, doc drop module 130 can also provide facilities to perform database searches. Typically, no additional authentication by the user is necessary, since the search facility provided by doc drop module 130 employs pre-established access rights associated with any database to which a user has previously been authenticated. Thus, through use of the search facility provided by doc drop module 130, documents can be downloaded, viewed, or otherwise manipulated, wherein the ability to download, view, or otherwise manipulate documents is governed or constrained by a user's previously established access rights and is generally conducted through utilities provided by doc drop module 130.

Doc drop module 130 allows users to search, print, archive, upload, and download from databases without the user having to perform multiple authentications; databases are never directly manipulated by users, all interactions with the database are performed through doc drop module 130. Doc drop module 130 therefore facilitates all database access thus mitigating unnecessary database locks, lock contention, priority inversions (e.g., where high priority tasks are blocked by low priority tasks holding the common lock), and the like. Doc drop module 130 thus provides a two-way interface with the database (e.g. database 140) allowing users to access content persisted in the database, as well as allowing users to indirectly (e.g., through doc drop module 130) manipulate the content stored in the database. It will be noted that users are not typically accorded direct access to databases, all access to databases is provisioned through doc drop module 130 or facilities provided by doc drop module 130.

In addition to the foregoing, doc drop module 130 allows users to import multiple documents dropped into/onto doc drop element 108, wherein the multiple documents are in different formats. For example, one document can include comma separated values, another document can be a text document, a further document can be a word processor formatted document, and still yet another document can be formatted as a spreadsheet. Where doc drop module 130 detects or ascertains that multiple documents have been dropped over doc drop element 108, it can determine whether or not the documents have disparate format types. In response to doc drop module 130 identifying that the multiple documents dropped over doc drop module 108 have different format types, doc drop module 130 can associate keywords included in one or more identified documents to be tied with the documents. The keywords can be utilized when the documents are subsequently uploaded to the database 140. For example, when a user drags and drops multiple documents over doc drop element 108, doc drop module 130, on identifying that documents with disparate format types have been presented, can open up supplementary windows that can request the user to supply further information regarding the document/documents placed over/onto that the doc drop element 108. Typical information regarding document/documents placed over onto the doc drop element 108 can include, for instance, searchable keywords, possible locations within the database 140, and the like. As a function of, or based at least in part on, the keywords the doc drop module 130 can auto-name documents, and through the use of doc drop module 130, a user can both name (or rename) documents, by either accepting or rejecting (e.g., by entering a name of the user's choosing or modifying the name generated by doc drop module 130), the document name generated by doc drop module 130, and annotate the documents.

The auto-name feature can typically be constrained to a predetermined naming convention that can be based, for example, on an underlying database structure and/or corporate mandate. For instance, if a document pertains to a pleading, when such a document is dragged over doc drop element 108 and/or the user identifies the document as being a pleading, the system, or more particularly doc drop module 130, can generate and display supplementary windows requesting that the user provide further information, such as the case number. Doc drop module 130 can therefore name the document as “pleading-case number”, for example. Additionally and/or alternatively, the document can be associated with an original name and/or a revision of a previously named document where the document already exists or has previously been persisted in the database 140.

Where doc drop module 130 ascertains that a document has previously been persisted in database 140, doc drop module 130 can inform the user that there currently exists a document with the same name. In this case, doc drop module 130 can request that the user provide a new name, automatically provide the document with a revision number, or request that the user supply a revision number, for instance. In this context, it will be appreciated by those of ordinary skill in the art, that where necessary the file persisted in database 140 can be overwritten or replaced with the document recently dragged and dropped over doc drop element 108.

Users, through use of the viewer facility mentioned above, can also rename, revise, or annotate documents that have been placed in the format specific queues. Additionally, through functionalities provided by the viewer facility users can split documents apart so that new material can be inserted and thereafter the document rejoined to form a single document once again. Similarly, obsolete information can be discarded, replaced, modified, or updated. Annotations to the documents can also be appended to the document through the viewer facility additionally and/or alternatively, hyperlinks can be added, removed, or modified within the document. Further, the viewer facility allows formatted PDF documents, for example, to be edited/manipulated in any manner of the user's choosing. Where the document is a non-PDF document, such as a word processing document, spreadsheet document, document formatted to be accessed/manipulated by a graphical presentation program, etc., the document can be converted extemporaneously to a portable document format.

In connection with the queues and queuing facilities provided by doc drop module 130, it should be noted that uploads to the database (e.g., database is 140) typically takes place when connectivity to the database is established. Thus, when a user is manipulating documents and/or dragging and dropping documents over persistent doc drop element 108 while his/her computing device 150 is not communicatively coupled to database 140, the manipulated documents and/or documents that have been dragged over and dropped on persistent doc drop element 108 can be persisted in one or more format specific queues. When communications between computing device 150 and database 140 has been established/reestablished, the documents persisted in the one or more format specific queues can be uploaded to the database 140 and the data thereafter synchronized in database 140. It should be noted that when communication between computing device 150 and database 140 is established/reestablished, document synchronization with the database is not necessarily automatic (e.g., documents resident within the one or more various format specific queues are not automatically uploaded to the database 140); a setting or flag related as to whether or not automatic updates is to be performed can be utilized to achieve this facility.

Doc drop module 130, in addition to the functionalities and facilities outlined above, has the ability to obtain documents from an associated scanner. In accordance with this aspect, a user through use of persistent doc drop element 108 and/or graphical user interface 106 can cause a document to be scanned by the associated scanner, queued to one or more format specific queues, and thereafter to be uploaded to database 140, where if necessary further processing can take place.

In further embodiments and as noted above, doc drop module 130, in conjunction with, for instance, operating system interface module 110, doc drop generator module 112, user interface module 114, listener module 116, can generate graphical user interface 106 and persistent doc drop element 108 that can be utilized to retrieve, print, scan, e-mail documents. In particular, persistent doc drop element 108 can provide an interface through which access to database 140 can be facilitated. It should be noted that access through persistent doc drop element 108 allows a user to indirectly access database 140; the user is typically not accorded a direct interaction with database 140. Thus, all interactions between a user (e.g., using persistent doc drop element 108) and database 140 are facilitated through persistent doc drop element 108, wherein access rights, privileges, and credentials to modify database 140 is typically performed using the rights, privileges, and credentials associated with or accorded to the user. To facilitate such database access therefore, persistent doc drop element 108 can typically be imbued with the user's database access rights, privileges, and credentials. Thus, if a first user has been provided credentials A, B, C to access database 140, persistent doc drop element 108 will similarly be accorded access credentials A, B, and C to access and/or manipulated the database 140. Similarly, where a second user has been provided database credentials X, Y, Z, the persistent doc drop element 108 utilized by the second user will be accorded or granted mirroring credentials X, Y, and Z.

In accordance with the foregoing, it should be noted that a user can, at any instance in time, be associated with multiple persistent doc drop elements, wherein each persistent doc drop element can be associated with various distinct credentials. Thus, a user through the persistent doc drop element can populate or manipulate different databases or aspects of the database. Thus for instance, a user might have a first persistent doc drop element associated with a first database (e.g., a customer relationship management (CRM) database), a second persistent doc drop element associated with a second database (e.g., a database associated with a social networking site), and/or a third persistent doc drop element associated with one or more databases affiliated with one or more other websites and/or cloud storage arenas.

In yet further embodiments, doc drop module 130, in collaboration with the other enumerated aspects included in doc drop module 130, can generate a persistent doc drop element 108 that can archive material to populate various databases, as well as contemporaneously generate and dispatch communications via e-mails, Short Message Service (SMS), Multimedia Message Service (MMS), and the like, to one or more concerned parties. For instance, where a user drags and drops over persistent doc drop module 108 a picture to be uploaded to a social networking site, when the picture is uploaded and/or persisted in the databases associated with the social networking site, a notification/communication can automatically be sent to all the user's friends/associates regarding this event. Once again, it should be noted, the user's sole interaction is with the persistent doc drop element 108; the user typically does not directly interact with the social networking site and/or its associated databases, rather the persistent doc drop element 108 alone performs the interaction with the social networking site, thus obviating the necessity for the user to establish connection with the social networking site and/or its affiliated databases. Moreover, in this regard, since persistent doc drop elements can be affiliated with several sites at the same time, the user need only drag and drop an item (e.g., document, image, video, and the like) over persistent doc drop element 108 once in order to populate multiple databases associated with disparate websites. For example, a user may wish to upload an image to his/her social networking website, business social networking website, online dating website, and the like. Through use of a persistent doc drop element 108 associated with each of these websites, the user can upload the picture to each of the websites by dragging and dropping the image onto the persistent doc drop element 108 once and having the persistent doc drop element 108 populate each of the associated databases and websites. In this manner the need for the user to authenticate and establish connection with each of the disparate websites multiple times is obviated.

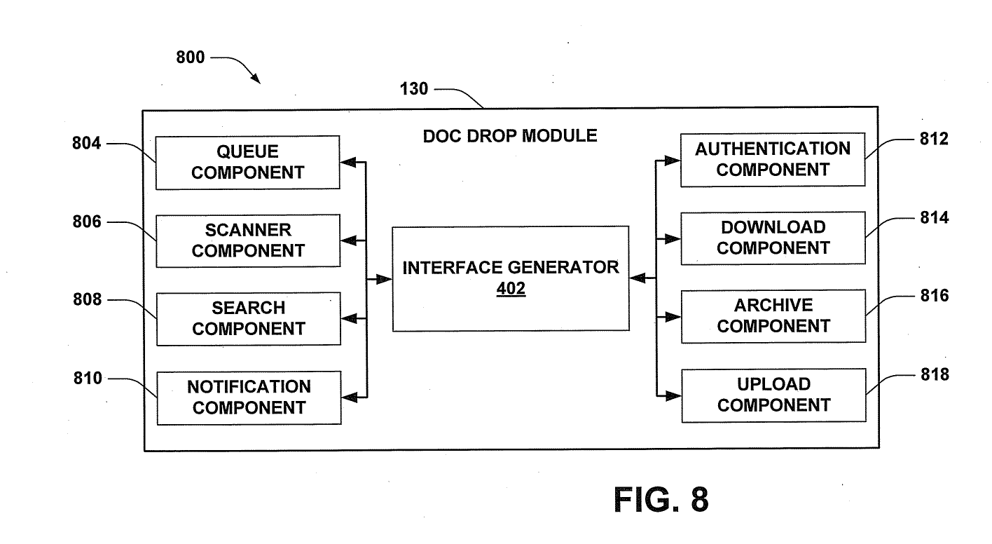

Turning now to FIG. 8 that provides further illustration of doc drop module 130. As depicted, drop module 130 can include an interface generator 402 that can generate an interface (e.g., persistent doc drop element 108) that facilitates a user's interaction with one or more databases (e.g., database 140) and/or one or more disparate websites/web services.

Additionally, as also depicted in FIG. 8 doc drop module 130 can also include queue component 804, wherein when a user drags and drops documents/files formatted in various disparate file formats into/onto persistent doc drop element 108, queue component 804 can extemporaneously convert these documents into one or more alternate document formats. For instance, when a user drops into/onto persistent doc drop element 108 a document formatted in a word processing format, queue component 804 can convert the document into a more convenient/consistent format such as a portable document format (PDF) and thereafter can convey or queue the converted document to a format and/or task specific queue. As has been noted above, additionally and/or alternatively, converted documents can be conveyed directly to one or more databases, web page, website, or web service specific queues, whereupon at the end of the day, at the conclusion of business, or on completion of a particular task, for instance, the content of each respective queue can be uploaded to the database (e.g. database 140) as respective single files. Additionally and/or alternatively, the content of format specific queues can periodically, on demand, be uploaded to a database or one or more disparate databases.

It should be noted that the one or more format or task specific queues controlled, managed, or monitored by queue component 804 can typically be placed in a hold state to effectuate the queuing of format specific content, whereupon at the conclusion of a user's session, for example, the format specific queue can be released and queued content can be uploaded or conveyed to one or more databases, web pages, websites, or web service. It should further be noted that the number of queues that can be controlled, managed, or monitored by queue component 804 can be unlimited and each queue can be populated simultaneously.

In addition to the foregoing, doc drop module 130 can include scanner component 806 that provides users the ability to obtain documents from an associated scanner. In accordance with this aspect, a user, through use of aspects of persistent doc drop element 108, can cause a document to be scanned by the associated scanner, wherein after the scanned document can be queued to one or more format specific and/or task specific queues, and thereafter subsequently be uploaded to database 144 for further processing.

Additionally, doc drop module 130 can further include search component 808 that can be utilized by users to search databases, websites, web pages, or web services for items of interest or relevance to a particular task being undertaken by a user. It should be appreciated in accordance with this feature that no additional authentication by the user is necessary as search component 808 can utilize pre-established access rights associated with any database, website, web page, or web service to which the user has previously been authenticated. Thus, through use of search component 808, a user can download, upload, view, or otherwise manipulate documents persisted to any database, website, web page, or web service, wherein the ability to search, download, upload, view, manipulate documents is governed or constrained by a user's previously established access credentials or rights to the database, website, web page, or web service at issue.

Doc drop module 130 can further include notification component 810 that can be employed to dispatch notification to persons affiliated with the user. Notification component 810 can dispatch notifications in one or more disparate formats, such as electronic mail, text message, short message service (SMS), multimedia message service (MMS), and the like, 210 more concerned party. For example, were a user drags and drops over persistent doc drop element 108 a picture to be uploaded to a social networking site, when the picture is uploaded and/or persisted in the databases associated with the social networking site, a notification can be automatically generated and dispatch by notification component 810 to all the user's friends/associates regarding this event. As has been noted previously, the user's sole interaction in this instance is with doc drop element 108; the user generally does not have a direct interaction with the social networking site and/or its associated databases. Rather, access to the social networking site is facilitated through facilities provided by doc drop element 108 in conjunction with functionalities provided by doc drop module 130 (e.g., queue component 804, scanner component 806, notification component 810, authentication component 812).

Further, doc drop module 130 can include authentication component 812 that can allow users to directly and/or indirectly (e.g., without having, or without repeatedly having, to supply access credentials, rights, privileges) interact with one or more databases, web sites, web pages, and/or web services. Authentication component 812, in accordance with an aspect, can maintain an associative database of user access credentials, rights, and privileges, wherein a user and his or her access credentials, rights, and privileges can be associated with one or more databases, websites, web pages, and/or web services to which the user has authorized access. Thus, authentication component 812 can work in conjunction with persistent doc drop element 108 to facilitate access by user to the one or more databases, websites, web pages, and/or web services. It should be noted in connection with authentication component 812, that users can at any instant in time be associated with multiple doc drop elements (e.g., multiple instances of persistent doc drop element 108) and each of these multiple doc drop elements can be associated with distinct security credentials, access rights, and/or privileges. Thus, authentication component 812 can maintain a user's security credentials and access rights and privileges for each of these distinct multiple doc drop elements.

Further, doc drop module 130 can also include download component 814, archive component 816, and upload component 818 that in conjunction with one or more enumerated components included in doc drop module 130 can allow a user to upload, download, and/or archive documents to a database, web page, website, and/or web service. As has been noted previously, uploading, downloading, and/or archiving documents to the various disparate databases, web pages, websites, and/or web services can be performed through use of persistent doc drop element 108 in conjunction with, for example, authentication component 812. Thus, when each of download component 814, archive component 816, and upload component 818 are interacting with a database, web page, website, and/or web service, each of download component 814, archive component 816, and upload component 818 can mitigate unnecessary database locks, lock contention, priority inversions, and the like, that can typically be manifest when multiple users or processes access a resource.

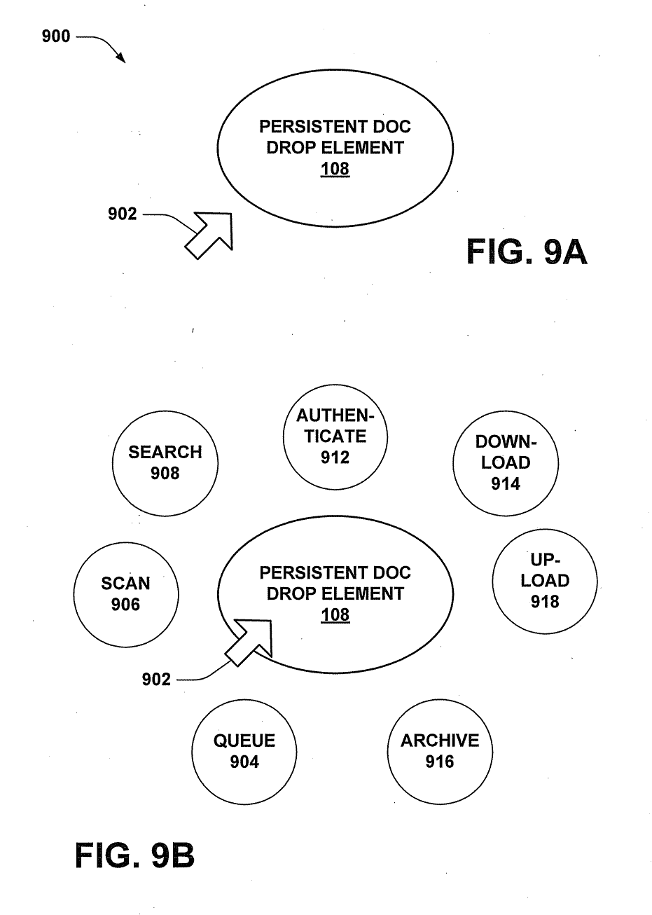

Turning now to FIG. 9A and FIG. 9B that illustrates an example persistent doc drop element 108 that can be generated by doc drop generator module 112 and displayed on display 101. In FIG. 9A persistent doc drop module 108 is illustrated in a state where its associated ancillary features have not been deployed, whereas in FIG. 9B persistent doc drop module 108 is depicted with its associated ancillary features deployed. Deployment of associated ancillary features can be effectuated by moving mouse pointer 902 over (or in close proximity to) persistent doc drop element 108, as is illustrated in FIG. 9B. When mouse pointer 902 is moved away from persistent doc drop element 108 the deployed ancillary features can be retracted to minimize the display real estate taken up by the persistent doc drop element 108 and its deployed ancillary features. With regard to the ancillary features that deploy as a function, or consequence, of mouse pointer 902 being brought in close proximity or over persistent doc drop element 902, the ancillary features (e.g., queue 904, scan 906, search 908, authentication 912, download 914, upload 918, and archive 916) the can be corollary or counterpart aspects to queue component 804, scanner component 806, search component 808, authentication component 812, download component 814, archive component 816, and upload component 818 as depicted in FIG. 8.

It should be noted in the context of the above enumerated ancillary features, that each of these features can also expand out to reveal further functionalities associated with the ancillary feature when mouse pointer 902 hovers over or is brought within the vicinity of an ancillary features. For example, in response to mouse pointer 902 being brought into close proximity to search feature 908, further ancillary functionality can be displayed, such as a graphical user interface permitting a user to input search terms, database to search, etc.

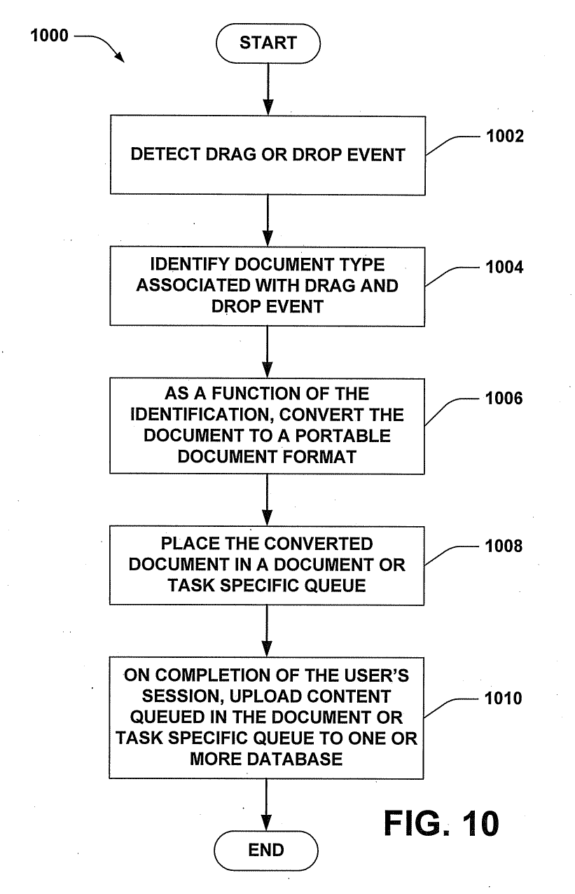

FIG. 10 illustrates a methodology in accordance with the disclosed subject matter. For simplicity of explanation, the methodology is depicted and described as a series of acts. It is to be understood and appreciated that the subject application is not limited by the acts illustrated and/or by the order of acts. For example, acts can occur in various orders and/or concurrently, and with other acts not presented or described herein. Furthermore, not all illustrated acts may be required to implement the methodology in accordance with the disclosed subject matter. In addition, those skilled in the art will understand and appreciate that the methodology could alternatively be represented as a series of interrelated states via a state diagram or events. Additionally, it should be further appreciated that the methodology disclosed hereinafter and throughout this specification is capable of being stored on an article of manufacture to facilitate transporting and transferring such methodology to computers. The term article of manufacture, as used herein, is intended to encompass a computer program accessible from any computer-readable device, carrier, or media.

FIG. 10 depicts a methodology 1000 that can be utilized for uploading one or more documents to a document management database. Methodology 1000 can commence at 1002 where a drag and drop event can be detected through use of listener module 118. Typical drag and drop events can occur when a user drags and/or drops (e.g., using a pointer device such as a mouse, stylus, etc.) one or more documents over persistent doc drop element 108. At 1004 upon detecting a drag and drop event each of the one or more documents dragged and/or dropped onto/into persistent doc drop element 108 the document type (e.g., text document, word processing document, spreadsheet document, postscript document, and the like) can be ascertained or identified. At 1006, as a function of the identification carried out at 1004, each of the documents can be converted to a portable document format. At 1008 the converted documents can be placed or queued in one or more document or task specific queues. At 1010 on completion of the user's session (or on completion of a particular task), the content queued in each of the document or task specific queues can be uploaded to one or more databases, web sites, web pages, or web services for further processing.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in storage systems described above, non-volatile memory 1122 (see below), disk storage 1124 (see below), and memory storage 1146 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

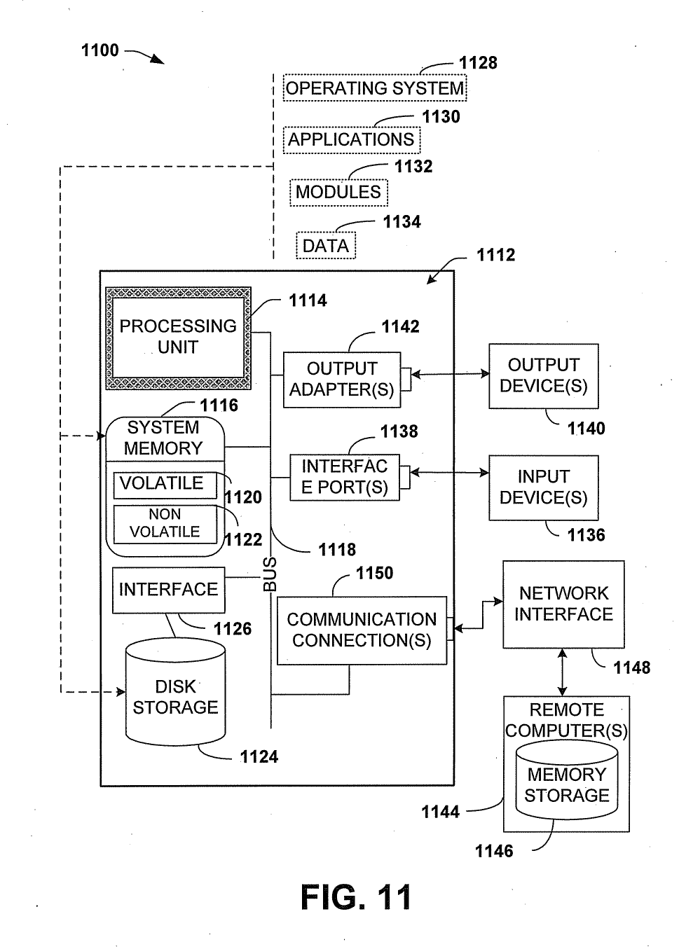

In order to provide a context for the various aspects of the disclosed subject matter, FIG. 11, and the following discussion, are intended to provide a brief, general description of a suitable environment in which the various aspects of the disclosed subject matter can be implemented, e.g., various processes associated with FIGS. 1-10. While the subject matter has been described above in the general context of computer-executable instructions of a computer program that runs on a computer and/or computers, those skilled in the art will recognize that the subject application also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 11, a block diagram of a computing system 1100 operable to execute the disclosed systems and methods is illustrated, in accordance with an embodiment. Computer 1112 includes a processing unit 1114, a system memory 1116, and a system bus 1118. System bus 1118 couples system components including, but not limited to, system memory 1116 to processing unit 1114. Processing unit 1114 can be any of various available processors. Dual microprocessors and other multiprocessor architectures also can be employed as processing unit 1114.

System bus 1118 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1116 includes volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can include ROM, PROM, EPROM, EEPROM, or flash memory. Volatile memory 1120 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 can also include removable/non-removable, volatile/non-volatile computer storage media, networked attached storage (NAS), e.g., SAN storage, etc. FIG. 11 illustrates, for example, disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

It is to be appreciated that FIG. 11 describes software that acts as an intermediary between users and computer resources described in suitable operating environment 1100. Such software includes an operating system 1128. Operating system 1128, which can be stored on disk storage 1124, acts to control and allocate resources of computer 1112. System applications 1130 take advantage of the management of resources by operating system 1128 through program modules 1132 and program data 1134 stored either in system memory 1116 or on disk storage 1124. It is to be appreciated that the disclosed subject matter can be implemented with various operating systems or combinations of operating systems.

A user can enter commands or information into computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 1114 through system bus 1118 via interface port(s) 1138. Interface port(s) 1138 include, for example, a serial port, a parallel port, a game port, and a universal serial bus (USB). Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140 like monitors, speakers, and printers, among other output devices 1140, which use special adapters. Output adapters 1142 include, by way of illustration and not limitation, video and sound cards that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, a workstation, a microprocessor based appliance, a peer device, or other common network node and the like, and typically includes many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory;
a listener component that detects when a document has been dragged or dropped onto a persistent doc drop element; and
a doc drop module that, as a function of the document being dragged or dropped onto the persistent doc drop element, converts the document into a portable document format and queues a converted document to a task specific queue, and in response to a user terminating a task associated with the task specific queue, uploads content queued in the task specific queue to a database associated with a web service.

2. The system of claim 1, wherein the document dragged or dropped onto the persistent doc drop element is converted in one or more of a word processing format, a spreadsheet format, a postscript format, or a text format.

3. The system of claim 1, wherein the doc drop module generates and dispatches a notification to a friend of the user informing the friend that queued content has been uploaded to the database associated with the web service.

4. The system of claim 1, wherein the doc drop module maintains authentication information associated with the user, the authentication information is utilized by the doc drop module to establish connection with the database associated with the web service without interaction with the user.

5. The system of claim 1, wherein the doc drop module activates a scanner to acquire a document in response to the user activating a first functionality associated with the persistent doc drop element.

6. The system of claim 5, wherein the document acquired by the scanner in response the user activating the first functionality associated with the persistent doc drop element is queued to the task specific queue.

7. The system of claim 1, wherein the doc drop module, in response to the user activating a second functionality associated with the persistent doc drop element, searches the database associated with the web service for an item of interest to the user.

8. The system of claim 7, wherein as a function of a placement of a pointing device cursor over the second functionality, the doc drop, module generates a user input interface for the user to enter a search term for the item of interest to the user.

9. The system of claim 1, wherein the doc drop module, as a function of the user activating a third functionality associated with the persistent doc drop element by hovering a representation of a pointing device cursor over the persistent doc drop element, causes a format specific viewer to display document included in the task specific queue.

10. A method, comprising:
listening for a drag or drop event, wherein a document is dragged or dropped over a persistent doc drop element;
transforming the document from a first document format to a second document format;
placing the document transformed to the second document format into a task specific queue or a format specific queue; and
transferring the document transformed to the second document format from the task specific queue or the format specific queue to a document management database associated with a web service.

11. The method of claim 10, wherein the first document format includes one of one or more word processing format, one or more spreadsheet format, a postscript format, one or more structured hypertext markup language (HTML) format, one or more file formats for multimedia and vector graphics, or one or more digital encoding formats.

12. The method of claim 10, wherein the second document format includes a portable document format.

13. The method of claim 10, wherein the transferring commences in response to releasing the task specific queue or the format specific queue from a hold state.

14. The method of claim 10, wherein the transferring commences as a function of a user terminating execution of the persistent doc drop element.

15. The method of claim 14, further comprising generating a notification broadcast to a friend of the user terminating execution of the persistent doc drop element.

16. The method of claim 15, wherein the notification is broadcast using one of an electronic mail, short message service (SMS), or multimedia message service (MMS).

17. A system, comprising:
at least one non-transitory computer readable medium having stored thereon computer-executable components;
at least one microprocessor that executes the following computer executable components stored on the at least one non-transitory computer readable medium:
a listener component that detects an event that includes reception of a document formatted in a first data format by a persistent doc drop element;
a queue component that transforms the document formatted in the first format into a document formatted in a second data format, wherein the document formatted in the second format is placed in a task specific queue that is maintained in a hold state; and
a database interface component that transfers the document formatted in the second format to a document management database associated with a web service in response to the task specific queue being released from the hold state.

18. The system of claim 17, wherein the task specific queue is released from the hold state in response to execution of the persistent doc drop element being terminated.

19. The system of claim 17, further comprising, in response to activation of a first functionality presented by the persistent doc drop element, a scanner component that activates a remote scanner to scan a document formatted in the second format, wherein the document formatted in the second format is placed in the task specific queue.

20. The system of claim 17, further comprising, in response to activation of a second functionality presented by the persistent doc drop element, a download component retrieves a document formatted in the second format from the document management database associated with the web service.
